(19) United States
(12) Patent Application Publication
(10) Pub. No.: US 2026/0336002 A1
(43) Pub. Date: Oct. 29, 2026

(54) Electrical Discharge Machining Apparatus and Electrical Discharge Machining Method Thereof

(71) Applicant: National Kaohsiung University of Science and Technology, Kaohsiung City (TW)

(72) Inventors: WEN-JENG HSUE, Kaohsiung City (TW); JIA-MING CHUANG, Chiayi County (TW)

(21) Appl. No.: 19/363,573

(22) Filed: Oct. 20, 2025

(30) Foreign Application Priority Data
Apr. 28, 2025 (TW) 114115970

(51) Int. Cl. B23H 7/36; B23H 7/28

(52) U.S. Cl. CPC B23H 7/36; B23H 7/28

(57) ABSTRACT

An electrical discharge machining apparatus and an electrical discharge machining method thereof are configured to perform electrical discharge machining on a workpiece machining zone of a workpiece. The electrical discharge machining apparatus comprises a machining tool and an atomization module. The machining tool comprises a tool machining structure, and the tool machining structure is configured to enter the workpiece machining zone to perform electrical discharge machining on the workpiece. The atomization module is configured to receive a dielectric solution so as to atomize the dielectric solution to generate dielectric mist droplets, moreover, the dielectric solution contains a EDM dielectric fluid and EDM particles, and then provide the dielectric mist droplets to the workpiece machining zone, such that the dielectric mist droplets participate in the electrical discharge machining performed by the tool machining structure on the workpiece, thereby improving discharge stability of the electrical discharge machining apparatus, and even allowing the workpiece machining zone to form special patterns.

### CROSS-REFERENCE TO RELATED APPLICATIONS

This application claims the priority of Republic of China Patent Application No. 114115970 filed on Apr. 28, 2025, in the State Intellectual Property Office of the R.O.C., the disclosure of which is incorporated herein by reference.

### BACKGROUND OF THE INVENTION

### Field of the Invention

The present application relates to the technical field of electrical discharge machining apparatus, and more particularly, to an electrical discharge machining apparatus capable of improving the debris removal efficiency of machining debris in a discharge passage.

### Descriptions of the Related Art

In general, Electrical Discharge Machining (EDM) is a metal machining technology that utilizes arc discharge in a discharge passage to perform machining, which is particularly suitable for the precision machining requirements of conductive materials having complex shapes and being difficult to cut. However, during the process of electrical discharge machining, unstable discharge phenomena often occur, resulting in poor electrical discharge machining efficiency, poor roughness, morphology, and dimensional accuracy of a machined portion of a workpiece, and even causing excessively rapid passivation consumption of an end portion of an electrical discharge machining tool.

In view of the foregoing, how to improve the discharge stability of an electrical discharge machining apparatus is indeed a problem urgently to be solved by those skilled in the art.

### SUMMARY OF THE INVENTION

In view of the drawbacks of the prior art mentioned above, the present application provides an electrical discharge machining apparatus configured to perform an electrical discharge machining on a workpiece machining zone of a workpiece, the electrical discharge machining apparatus comprising: an apparatus body configured to position the workpiece and provide a dielectric solution; a machining tool comprising a tool machining structure; an actuation module configured to actuate the machining tool; an atomization module configured to receive the dielectric solution so as to atomize the dielectric solution to generate dielectric mist droplets, and the atomization module comprising at least one mist droplet nozzle and a workpiece abutting insulator, the mist droplet nozzle being disposed on the workpiece abutting insulator and the mist droplet nozzle is interconnected with the workpiece abutting insulator, and the workpiece abutting insulator comprises a tool machining passage; a movement module comprising at least one movement track, wherein the workpiece abutting insulator is disposed on the movement track, wherein the workpiece abutting insulator is movable on the movement track to abut the workpiece, thereby aligning the mist droplet nozzle and the tool machining passage with the workpiece machining zone; and a control module configured to control the actuation module to actuate the machining tool such that the tool machining structure passes through the workpiece abutting insulator via the tool machining passage to enter the workpiece machining zone for performing electrical discharge machining on the workpiece, and the control module is further configured to control the atomization module such that the mist droplet nozzle provides the dielectric mist droplets to the workpiece machining zone, allowing the dielectric mist droplets to participate in the electrical discharge machining performed by the tool machining structure on the workpiece.

Preferably, the electrical discharge machining apparatus said above, wherein the electrical discharge machining apparatus is further operable with a high pressure gas, and the atomization module is further configured to receive the high pressure gas so as to force the dielectric solution to be atomized by the high pressure gas.

Preferably, the electrical discharge machining apparatus said above, wherein the atomization module further comprises an oscillator configured to provide oscillation to force the dielectric solution to be atomized.

Preferably, the electrical discharge machining apparatus said above, wherein the machining tool further comprises a tool inner flow path configured to enter the workpiece machining zone along with the tool machining structure, and the electrical discharge machining apparatus further comprises a negative pressure module in continuity with the tool inner flow path, during the electrical discharge machining of the workpiece, the control module is configured to control the negative pressure module such that the negative pressure module provides negative pressure suction to the workpiece machining zone via the tool inner flow path, forming a negative pressure flow field in the workpiece machining zone, and a fluid driven by the negative pressure flow field drives the dielectric mist droplets to enter the workpiece machining zone, allowing the dielectric mist droplets to participate in the electrical discharge machining performed by the tool machining structure on the workpiece, and then drives the dielectric mist droplets to leave the workpiece machining zone via the tool inner flow path.

Preferably, the electrical discharge machining apparatus said above, wherein the electrical discharge machining performed by the tool machining structure on the workpiece generates machining debris in the workpiece machining zone, and the negative pressure flow field further forms a fluid to drive the machining debris, thereby driving the machining debris to leave the workpiece machining zone via the tool inner flow path.

Preferably, the electrical discharge machining apparatus said above, wherein the at least one mist droplet nozzle comprises a plurality of mist droplet nozzles, the plurality of mist droplet nozzles being distributed around the tool machining passage and oriented toward the workpiece machining zone.

Preferably, the electrical discharge machining apparatus said above, wherein the movement module further comprises an elastic member configured to provide an elastic force to force the workpiece abutting insulator to move on the movement track and abut the workpiece; and the movement track comprises two movement tracks, the two movement tracks being located on opposite sides of the workpiece abutting insulator, and structures of the two movement tracks being substantially the same such that the movement of the opposite sides of the workpiece abutting insulator is substantially the same.

Preferably, the electrical discharge machining apparatus said above, further comprising a stirring module configured to stir the dielectric solution so as to make components of the dielectric solution uniform.

Preferably, the electrical discharge machining apparatus said above, further comprising a liquid supply pump, and the apparatus body comprising a liquid containing tan configured to contain the dielectric solution, and the liquid supply pump being respectively in continuity with the liquid containing tank and the atomization module such that the atomization module is enable to receive the dielectric solution via the liquid supply pump.

Additionally, the present application provides an electrical discharge machining method configured to perform electrical discharge machining on a workpiece machining zone of a workpiece, the electrical discharge machining method comprising: providing an apparatus body, wherein the apparatus body positions the workpiece and provides a dielectric solution, wherein the dielectric solution comprises a mixture of an electrical discharge machining liquid and electrical discharge machining particles, the electrical discharge machining liquid comprising water or electrical discharge machining oil, the concentration of the electrical discharge machining particles in the dielectric solution being at least 0.01 ppm, and the electrical discharge machining particles have a particle size less than or equal to a discharge machining gap between the machining tool and the workpiece; providing a machining tool comprising a tool machining structure; providing an atomization module configured to receive the dielectric solution so as to atomize the dielectric solution to generate dielectric mist droplets; and allowing the tool machining structure to enter the workpiece machining zone to perform electrical discharge machining on the workpiece, and allowing the atomization module to provide the dielectric mist droplets to the workpiece machining zone, wherein the dielectric mist droplets participate in the electrical discharge machining performed by the tool machining structure on the workpiece.

Compared with the prior art, the present application provides at least one electrical discharge machining apparatus and an electrical discharge machining method thereof. The provided electrical discharge machining apparatus and electrical discharge machining method are configured to perform electrical discharge machining on a workpiece machining zone of a workpiece. The electrical discharge machining apparatus comprises a machining tool and an atomization module. The machining tool comprises a tool machining structure, the tool machining structure being configured to enter the workpiece machining zone to perform electrical discharge machining on the workpiece. The atomization module is configured to receive a dielectric solution so as to atomize the dielectric solution to generate dielectric mist droplets, and then provide the dielectric mist droplets to the workpiece machining zone, so that the dielectric mist droplets participate in the electrical discharge machining performed by the tool machining structure on the workpiece, thereby improving discharge stability of the electrical discharge machining apparatus, and even allowing the workpiece machining zone to form special patterns, and enabling the roughness, morphology, and dimensional accuracy of the workpiece machining zone of the workpiece to meet expectations.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic view illustrating a usage state of the electrical discharge machining apparatus of the present application.

FIG. 2 is a schematic view illustrating a usage state of the electrical discharge machining apparatus of the present application.

FIG. 3 is a schematic view illustrating a usage state of the electrical discharge machining apparatus of the present application.

FIG. 4 is a schematic view illustrating a usage state of the electrical discharge machining apparatus of the present application.

FIG. 5 is a schematic view illustrating a usage state of the electrical discharge machining apparatus of the present application.

FIG. 6 is a schematic view illustrating a usage state of the electrical discharge machining apparatus of the present application.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided such that this disclosure will be thorough and complete, and will fully convey the scope of the invention to those skilled in the art.

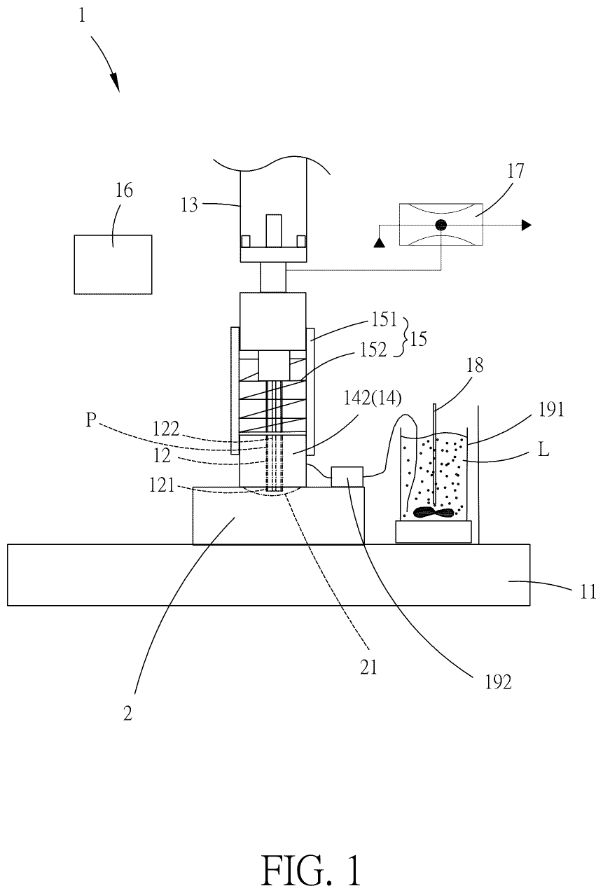

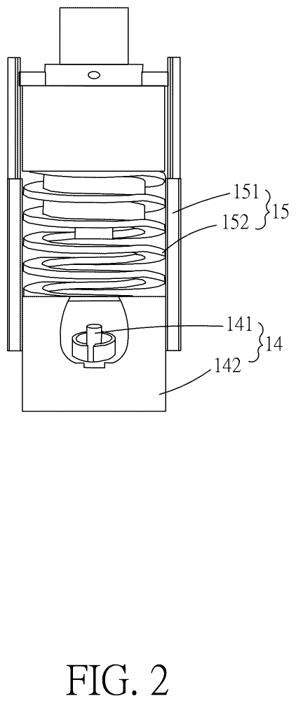

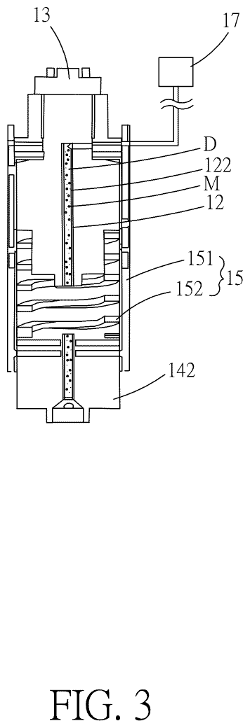

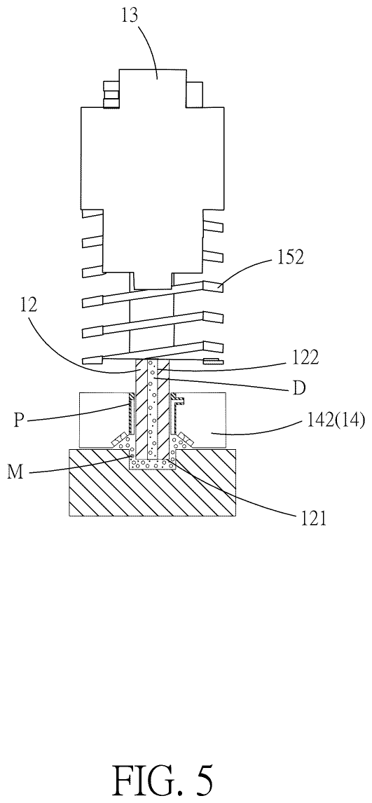

For a detailed description of the embodiments disclosed in the present application, please refer to FIGS. 1 to 6.

As shown in FIGS. 1 to 6, in an embodiment, the present application provides an electrical discharge machining apparatus 1 and an electrical discharge machining method thereof. The electrical discharge machining apparatus 1 is configured to perform electrical discharge machining on a workpiece machining zone 21 of a workpiece 2. The electrical discharge machining apparatus 1 comprises: an apparatus body 11, a machining tool 12, an actuation module 13, an atomization module 14, a movement module 15, a control module 16, and a negative pressure module 17.

Regarding the apparatus body 11, the apparatus body 11 is configured to position the workpiece 2 and provide a dielectric solution L. Optionally, the dielectric solution L comprises a mixture of an electrical discharge machining liquid and electrical discharge machining particles, the electrical discharge machining liquid comprising water or electrical discharge machining oil, the concentration of the electrical discharge machining particles in the dielectric solution being at least 0.01 ppm, and the particle size of the electrical discharge machining particles being less than or equal to a discharge machining gap between the machining tool 12 and the workpiece 2, so as to improve discharge stability of the electrical discharge machining apparatus 1, and even allow the workpiece machining zone 21 to form a special pattern, thereby enhancing the surface roughness quality of the workpiece machining zone 21. Optionally, the electrical discharge machining particles comprise graphite powder or silicon carbide powder.

As shown in FIG. 1, in an embodiment, the electrical discharge machining apparatus 1 further comprises a stirring module 18, a liquid containing tank 191, and a liquid supply pump 192. The liquid containing tank 191 is configured to contain the dielectric solution L. The stirring module 18 is configured to stir the dielectric solution L contained in the liquid containing tank 191 so as to mix the components of the dielectric solution L uniformly. The liquid supply pump 192 is respectively in continuity with the liquid containing tank 191 and the atomization module 14 such that the atomization module 14 is enable to receive the dielectric solution L via the liquid supply pump 192.

Regarding the machining tool 12, the machining tool 12 is configured to be used for electrical discharge machining, and comprises a tool machining structure 121 and a tool inner flow path 122. The actuation module 13 is, for example, a machining spindle configured to actuate the machining tool 12. Regarding the atomization module 14, the atomization module 14 is configured to receive the dielectric solution L, and provide energy by heating, vibrating, compressing, or rotating so as to atomize the dielectric solution L into very fine droplets, thereby converting the dielectric solution L into dielectric mist droplets M.

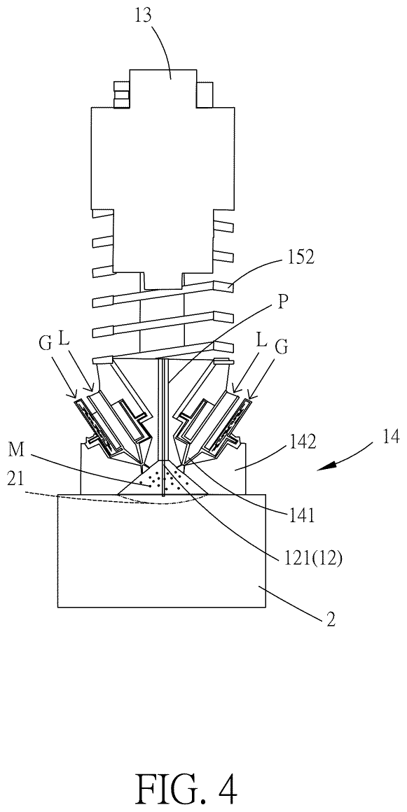

As shown in FIG. 4, in an embodiment, the electrical discharge machining apparatus 1 is further operable with a high pressure gas G, and the atomization module 14 is configured to receive the high pressure gas G so as to force the dielectric solution L to be atomized by the high pressure gas G.

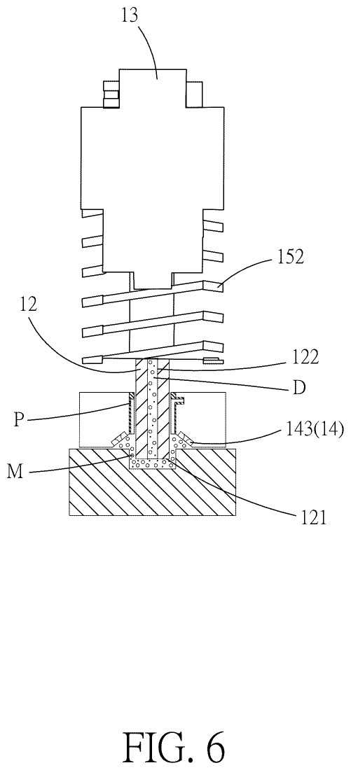

As shown in FIG. 6, in an embodiment, the atomization module 14 further comprises an oscillator 143, the oscillator 143 configured to provide oscillation to force the dielectric solution L to be atomized. Optionally, the oscillator 143 is an ultrasonic oscillator, such that vibration of the dielectric solution L surface and stress is enable to be generated by ultrasonic vibration, thereby dispersing the dielectric solution L into very fine droplets to generate the dielectric mist droplets M.

In the above embodiments, the atomization module 14 comprises at least one mist droplet nozzle 141 and a workpiece abutting insulator 142, the mist droplet nozzle 141 being disposed on the workpiece abutting insulator 142 such that the mist droplet nozzle 141 is interlocked with the workpiece abutting insulator 142, and the workpiece abutting insulator 142 comprises a tool machining passage P, the tool machining passage P configured to allow passage of the machining tool 12. Optionally, the at least one mist droplet nozzle 141 comprises a plurality of mist droplet nozzles 141, the plurality of mist droplet nozzles 141 being distributed around the tool machining passage P and oriented toward the workpiece machining zone 21.

Regarding the movement module 15, the movement module 15 comprises at least one movement track 151 and an elastic member 152. In the above embodiments, the workpiece abutting insulator 142 is disposed on the movement track 151, and the elastic member 152 is configured to provide an elastic force to force the workpiece abutting insulator 142 to move on the movement track 151 so as to maintain abutment with the workpiece 2, thereby aligning the mist droplet nozzle 141 and the tool machining passage P with the workpiece machining zone 21.

It should be noted that the movement track 151 may optionally be a slide rail so as to guide the workpiece abutting insulator 142 to move along a predetermined path. As shown in FIG. 1, in an embodiment, the movement track 151 comprises two movement tracks 151, the two movement tracks 151 being located at opposite sides of the workpiece abutting insulator 142 to guide the workpiece abutting insulator 142 to move at the opposite sides, wherein optionally, the structures of the two movement tracks 151 are substantially the same such that movement of the opposite sides of the workpiece abutting insulator 142 is substantially the same.

Regarding the control module 16, the control module 16 is configured to control the actuation module 13 to actuate the machining tool 12 such that the tool machining structure 121 passes through the workpiece abutting insulator 142 via the tool machining passage P and enters the workpiece machining zone 21 to perform electrical discharge machining on the workpiece machining zone 21 of the workpiece 2. At this time, the tool inner flow path 122 is configured to enter the workpiece machining zone 21 along with the tool machining structure 121, and the control module 16 is further configured to control the atomization module 14 such that the mist droplet nozzle 141 provides the dielectric mist droplets M to the workpiece machining zone 21, thereby providing a dielectric machining environment and allowing the dielectric mist droplets M to participate in the electrical discharge machining performed by the tool machining structure 121 on the workpiece 2, so as to improve the discharge stability of the electrical discharge machining apparatus 1.

Regarding the negative pressure module 17, the negative pressure module 17 is configured to provide negative pressure suction, and the negative pressure module 17 is in continuity with the tool inner flow path 122. It should be noted that when the electrical discharge machining apparatus 1 performs electrical discharge machining on the workpiece 2, the control module 16 is configured to control the negative pressure module 17 such that the negative pressure module 17 provides negative pressure suction to the workpiece machining zone 21 via the tool inner flow path 122, thereby forming a negative pressure flow field in the workpiece machining zone 21. A fluid driven by the negative pressure flow field drives the dielectric mist droplets M to enter the workpiece machining zone 21, such that the dielectric mist droplets M participate in the electrical discharge machining performed by the tool machining structure 121 on the workpiece 2, and then drives the dielectric mist droplets M to leave the workpiece machining zone 21 via the tool inner flow path 122.

It should be noted that the electrical discharge machining performed by the tool machining structure 121 on the workpiece 2 generates machining debris D in the workpiece machining zone 21, and the negative pressure flow field further forms a fluid to drive the machining debris D, thereby driving the machining debris D to leave the workpiece machining zone 21 via the tool inner flow path 122, so as to improve debris removal efficiency of the machining debris D in the workpiece machining zone 21, and avoid inter-electrode short circuit and abnormal discharge caused by the machining debris D in the workpiece machining zone 21, thereby improving electrical discharge machining efficiency and ensuring that the roughness, morphology, and dimensional accuracy of the workpiece machining zone of the workpiece meet expectations, and solving the problem of excessively rapid passivation consumption of the end portion of the electrical discharge machining tool.

It should be noted that, in the above embodiments, some of the above components may be omitted. For example, in the present application, the electrical discharge machining apparatus may optionally comprise: an apparatus body, a machining tool, an actuation module, an atomization module, a movement module, and a control module. The apparatus body is configured to position the workpiece and provide a dielectric solution. The machining tool comprises a tool machining structure. The actuation module is configured to actuate the machining tool. The atomization module is configured to receive the dielectric solution so as to atomize the dielectric solution to generate dielectric mist droplets, and the atomization module comprises at least one mist droplet nozzle and a workpiece abutting insulator, the mist droplet nozzle being disposed on the workpiece abutting insulator such that the mist droplet nozzle is interlocked with the workpiece abutting insulator, and the workpiece abutting insulator comprises a tool machining passage. The movement module comprises at least one movement track, wherein the workpiece abutting insulator is disposed on the movement track, wherein the workpiece abutting insulator is movable on the movement track to abut the workpiece, thereby aligning the mist droplet nozzle and the tool machining passage with the workpiece machining zone. The control module is configured to control the actuation module to actuate the machining tool such that the tool machining structure passes through the workpiece abutting insulator via the tool machining passage to enter the workpiece machining zone to perform electrical discharge machining on the workpiece, and the control module is further configured to control the atomization module such that the mist droplet nozzle provides the dielectric mist droplets to the workpiece machining zone, allowing the dielectric mist droplets to participate in the electrical discharge machining performed by the tool machining structure on the workpiece.

In addition, in the present application, the electrical discharge machining method may optionally comprise: providing an apparatus body, such that the apparatus body positions the workpiece and provides a dielectric solution, wherein the dielectric solution comprises a mixture of an electrical discharge machining liquid and electrical discharge machining particles, the electrical discharge machining liquid comprising water or electrical discharge machining oil, the concentration of the electrical discharge machining particles in the dielectric solution being at least 0.01 ppm, and the particle size of the electrical discharge machining particles being less than or equal to a discharge machining gap between the machining tool and the workpiece; providing a machining tool, the machining tool comprising a tool machining structure; providing an atomization module, the atomization module configured to receive the dielectric solution so as to atomize the dielectric solution to generate dielectric mist droplets; and allowing the tool machining structure to enter the workpiece machining zone to perform electrical discharge machining on the workpiece, and allowing the atomization module to provide the dielectric mist droplets to the workpiece machining zone such that the dielectric mist droplets participate in the electrical discharge machining performed by the tool machining structure on the workpiece.

In summary, the present application provides an electrical discharge machining apparatus and an electrical discharge machining method thereof. The provided electrical discharge machining apparatus and electrical discharge machining method are configured to perform electrical discharge machining on a workpiece machining zone of a workpiece. The electrical discharge machining apparatus comprises a machining tool and an atomization module. The machining tool comprises a tool machining structure, the tool machining structure configured to enter the workpiece machining zone to perform electrical discharge machining on the workpiece. The atomization module is configured to receive a dielectric solution so as to atomize the dielectric solution to generate dielectric mist droplets, moreover, the dielectric solution contains a EDM dielectric fluid and an EDM particles, and then provide the dielectric mist droplets to the workpiece machining zone, such that the dielectric mist droplets participate in the electrical discharge machining performed by the tool machining structure on the workpiece, thereby improving discharge stability of the electrical discharge machining apparatus, and even allowing the workpiece machining zone to form special patterns, and enabling the roughness, morphology, and dimensional accuracy of the workpiece machining zone of the workpiece to meet expectations.

The examples above are only illustrative to explain principles and effects of the invention, but not to limit the invention. It will be apparent to those skilled in the art that modifications and variations is enable to be made without departing from the spirit and scope of the invention. Therefore, the protection range of the rights of the invention should be as defined by the appended claims.

What is claimed is:

1. An electrical discharge machining apparatus configured to perform an electrical discharge machining on a workpiece machining zone of a workpiece, the electrical discharge machining apparatus comprising:
an apparatus body configured to position the workpiece and provide a dielectric solution;
a machining tool comprising a tool machining structure;
an actuation module configured to actuate the machining tool;
an atomization module configured to receive the dielectric solution so as to atomize the dielectric solution to generate dielectric mist droplets, and the atomization module comprising at least one mist droplet nozzle and a workpiece abutting insulator, the mist droplet nozzle being disposed on the workpiece abutting insulator and the mist droplet nozzle is interconnected with the workpiece abutting insulator, and the workpiece abutting insulator comprises a tool machining passage;
a movement module comprising at least one movement track, wherein the workpiece abutting insulator is disposed on the movement track, wherein the workpiece abutting insulator is movable on the movement track to abut the workpiece, thereby aligning the mist droplet nozzle and the tool machining passage with the workpiece machining zone; and
a control module configured to control the actuation module to actuate the machining tool such that the tool machining structure passes through the workpiece abutting insulator via the tool machining passage to enter the workpiece machining zone for performing electrical discharge machining on the workpiece, and the control module is further configured to control the atomization module such that the mist droplet nozzle provides the dielectric mist droplets to the workpiece machining zone, allowing the dielectric mist droplets to participate in the electrical discharge machining performed by the tool machining structure on the workpiece.

2. The electrical discharge machining apparatus of claim 1, wherein the electrical discharge machining apparatus is further operable with a high pressure gas, and the atomization module is further configured to receive the high pressure gas so as to force the dielectric solution to be atomized by the high pressure gas.

3. The electrical discharge machining apparatus of claim 1, wherein the atomization module further comprises an oscillator configured to provide oscillation to force the dielectric solution to be atomized.

4. The electrical discharge machining apparatus of claim 1, wherein the machining tool further comprises a tool inner flow path configured to enter the workpiece machining zone along with the tool machining structure, and the electrical discharge machining apparatus further comprises a negative pressure module in continuity with the tool inner flow path, during the electrical discharge machining of the workpiece, the control module is configured to control the negative pressure module such that the negative pressure module provides negative pressure suction to the workpiece machining zone via the tool inner flow path, forming a negative pressure flow field in the workpiece machining zone, and a fluid driven by the negative pressure flow field drives the dielectric mist droplets to enter the workpiece machining zone, allowing the dielectric mist droplets to participate in the electrical discharge machining performed by the tool machining structure on the workpiece, and then drives the dielectric mist droplets to leave the workpiece machining zone via the tool inner flow path.

5. The electrical discharge machining apparatus of claim 4, wherein the electrical discharge machining performed by the tool machining structure on the workpiece generates machining debris in the workpiece machining zone, and the negative pressure flow field further forms a fluid to drive the machining debris, thereby driving the machining debris to leave the workpiece machining zone via the tool inner flow path.

6. The electrical discharge machining apparatus of claim 1, wherein the at least one mist droplet nozzle comprises a plurality of mist droplet nozzles, the plurality of mist droplet nozzles being distributed around the tool machining passage and oriented toward the workpiece machining zone.

7. The electrical discharge machining apparatus of claim 1, wherein the movement module further comprises an elastic member configured to provide an elastic force to force the workpiece abutting insulator to move on the movement track and abut the workpiece; and the movement track comprises two movement tracks, the two movement tracks being located on opposite sides of the workpiece abutting insulator, and structures of the two movement tracks being substantially the same such that the movement of the opposite sides of the workpiece abutting insulator is substantially the same.

8. The electrical discharge machining apparatus of claim 1, further comprising a stirring module configured to stir the dielectric solution so as to make components of the dielectric solution uniform.

9. The electrical discharge machining apparatus of claim 1, further comprising a liquid supply pump, and the apparatus body comprising a liquid containing tan configured to contain the dielectric solution, and the liquid supply pump being respectively in continuity with the liquid containing tank and the atomization module such that the atomization module is enable to receive the dielectric solution via the liquid supply pump.

10. An electrical discharge machining method configured to perform electrical discharge machining on a workpiece machining zone of a workpiece, the electrical discharge machining method comprising:
providing an apparatus body, wherein the apparatus body positions the workpiece and provides a dielectric solution, wherein the dielectric solution comprises a mixture of an electrical discharge machining liquid and electrical discharge machining particles, the electrical discharge machining liquid comprising water or electrical discharge machining oil, the concentration of the electrical discharge machining particles in the dielectric solution being at least 0.01 ppm, and the electrical discharge machining particles have a particle size less than or equal to a discharge machining gap between the machining tool and the workpiece;
providing a machining tool comprising a tool machining structure;
providing an atomization module configured to receive the dielectric solution so as to atomize the dielectric solution to generate dielectric mist droplets; and
allowing the tool machining structure to enter the workpiece machining zone to perform electrical discharge machining on the workpiece, and allowing the atomization module to provide the dielectric mist droplets to the workpiece machining zone, wherein the dielectric mist droplets participate in the electrical discharge machining performed by the tool machining structure on the workpiece.
